(19) United States
(12) Patent Application Publication
(10) Pub. No.: US 2014/0052512 A1
(43) Pub. Date: Feb. 20, 2014

(54) SALES BONUS REWARD SYSTEM AND METHOD

(71) Applicant: Tien-Shu HSU, Taichung City (TW)

(72) Inventor: Tien-Shu HSU, Taichung City (TW)

(21) Appl. No.: 14/061,312

(22) Filed: Oct. 23, 2013

Related U.S. Application Data
(62) Division of application No. 13/367,993, filed on Feb. 7, 2012.

(51) Int. Cl. G06Q 30/02

(52) U.S. Cl. CPC G06Q 30/0212
USPC 705/14.14

(57) ABSTRACT

A sales bonus reward system and method includes a central controller, at least one cash register and a judgment unit. The central controller generates an accumulated award random value. The cash register generates a sales bonus after checkout of a consumption activity. The judgment unit accumulates the sales bonus to generate an accumulated sales bonus and offers the accumulated sales bonus as an incentive reward when it is greater than the accumulated award random value. Thus consumers are stimulated to spend more in order to get extra accumulated sales bonus in the consumption. As a result, business revenue can increase and profits can be boosted.

### CROSS REFERENCE TO RELATED APPLICATIONS

This application is a Divisional of co-pending application Ser. No. 13/367,993, filed on Feb. 7, 2012, for which priority is claimed under 35 U.S.C. §120, the entire contents of which are hereby incorporated by reference.

### FIELD OF THE INVENTION

The present invention relates to sales register and particularly to a sales register system and method.

### BACKGROUND OF THE INVENTION

In order to increase business revenues and stimulate and boost consumers' desire for consumption, many chain supermarkets or discount stores usually provide accumulation points for a selected amount of purchase. Based on checkout amount of consumers various amount of points are given for their accumulation. Some stores adopt a membership scheme to allow point accumulation based on the membership card, while some others adopt unnamed counting cards to accumulate the points. When the accumulated points have reached a specific threshold the card owner is entitled to exchange the accumulated points for selected merchandises or cash vouchers.

However, most consumers often have a limited purchase amount at one store. To accumulate enough points to exchange desired goods is quite difficult. Hence such a scheme usually becomes a pie in the sky to the consumers and provides no much purchase motivation, and is not very effective to increase business.

In order to motivate the consumers more effectively, vendors have to conduct regular promotional programs, such as offering award points as gifts, special discounts for selected amount of purchases, special promotional incentives for selected merchandises or the like to increase the reward amounts to attract the consumers. While such programs can boost business revenue, business profits could suffer. Hence management has to make comprehensive calculations of costs and tightly control promotional timing and merchandises. There is still room for improvement.

### SUMMARY OF THE INVENTION

Therefore the primary object of the present invention is to provide a sales bonus reward system that offers a promotional activity which is simple, easy to control costs and can stimulate consumption of consumers so as to boost business revenue and also maintain desired profits to meet business requirements.

Another object of the invention is to provide a sales bonus reward method to allow business management to easily control promotional costs and stimulate consumers' consumption desire to increase business revenue and also maintain desired profits.

To achieve the foregoing objects, the sales bonus reward system and method provided by the invention includes a central controller, at least one cash register and a judgment unit. The cash register is connected to the central controller. The judgment unit also is connected to the central controller.

The central controller generates an accumulated award random value and sets a bonus reward ratio for the cash register to generate a sales bonus according to the bonus reward ratio after checkout of each consumption activity. The judgment unit receives the sales bonus and accumulates the sales bonus to generate an accumulated sales bonus. In the event that the judgment unit judges that the accumulated sales bonus is greater than the accumulated award random value, the accumulated sales bonus is given as an incentive reward of the consumption activity.

Thus, according to the invention, the consumers have a chance to get extra accumulated sales bonus in the consumption activity that can be accumulated to become an attractive higher value award, thereby consumption desire can be stimulated and motivated. As a result, business revenue can be increased. Through the method of dispensing the sale bonus the cost can be easily controlled by altering the bonus reward ratio so that desired profits can be maintained to meet business requirements.

The foregoing, as well as additional objects, features and advantages of the invention will be more readily apparent from the following detailed description, which proceeds with reference to the accompanying embodiments and drawings. The embodiments serve merely for illustrative purpose and are not the limitations of the invention.

### BRIEF DESCRIPTION OF THE DRAWINGS

FIG. 1 is a system architecture of a first embodiment of the invention.

FIG. 2 is an operating flowchart of the first embodiment of the invention.

FIG. 3 is another system architecture of the first embodiment of the invention.

FIG. 4 is a system architecture of a second embodiment of the invention.

FIG. 5 is an operating flowchart of the second embodiment of the invention.

FIG. 6 is another system architecture of the second embodiment of the invention.

### DETAILED DESCRIPTION OF THE PREFERRED EMBODIMENTS

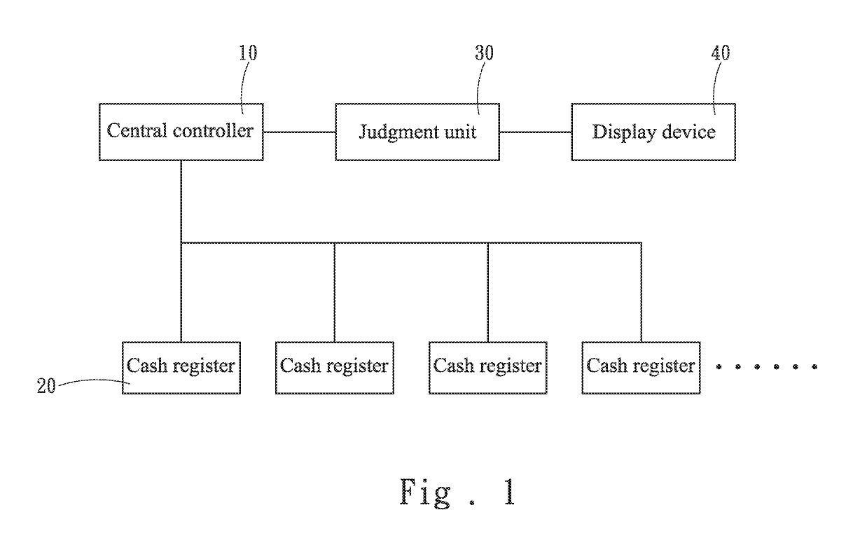

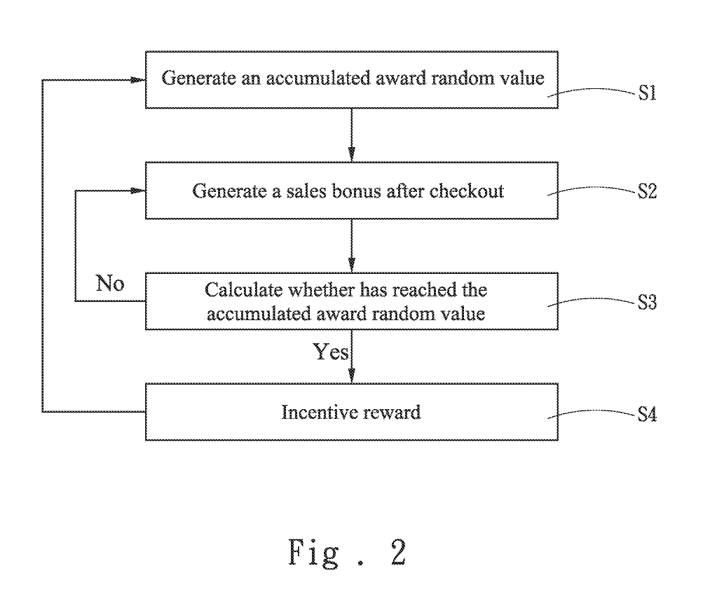

Please referring to FIGS. 1 and 2, the present invention aims to provide a sales bonus reward system which includes a central controller 10, at least one cash register 20 and a judgment unit 30. The cash register 20 is connected to the central controller 10. The judgment unit 30 also is connected to the central controller 10. The central controller 10 can set a bonus reward ratio.

The invention also provides a sales bonus reward method which includes the steps of: S1: generating an accumulated award random value; S2: generating a sales bonus after checkout; S3: calculating whether the accumulated award random value has been reached; and S4: offering an incentive reward.

At step S1, the central controller 10 generates randomly the accumulated award random value in a designated range of values.

At step S2, the cash register 20 generates the sales bonus based on the bonus reward ratio after checkout of a consumption activity. The bonus reward ratio can be set by vendors based on product gross profit ratio, or changed according to promotional requirements.

At steps S3 and S4, the judgment unit 30 receives the sales bonus to generate an accumulated sales bonus by accumulating the sales bonus. In the event that the accumulated sales bonus is greater than the accumulated award random value, proceed step S4 to offer the accumulated sales bonus as the incentive reward of the consumption activity; then determine whether to proceed step Si anew according to promotional program.

In addition, the invention also includes a display device 40 connecting to the judgment unit 30 to display the accumulated sales bonus so that consumers can be informed of the accumulated sales bonus instantly onsite to be stimulated for desire of consumption.

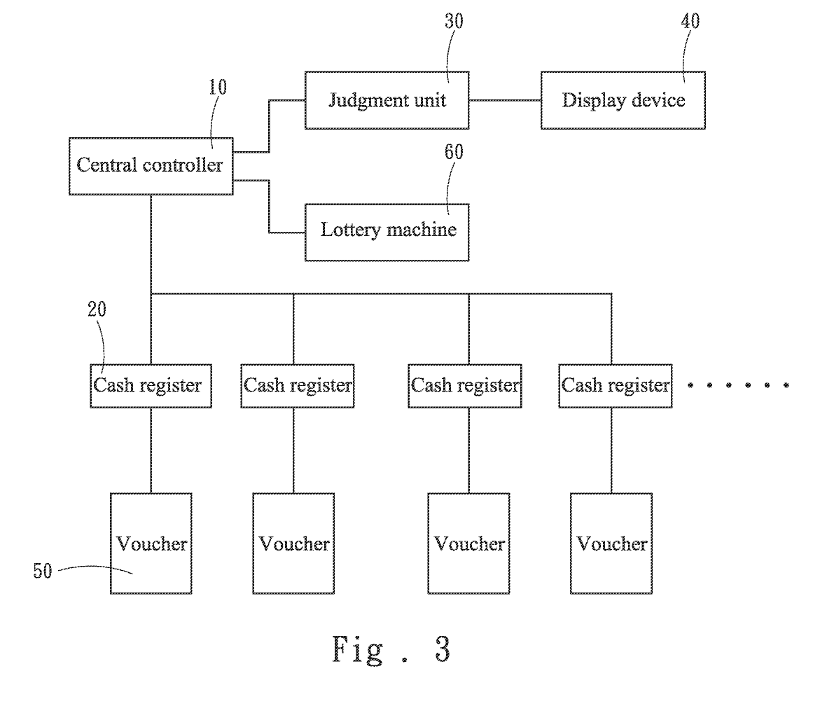

Referring to FIG. 3, in order to alleviate the workload of the cash register 20 and simplify merchandise return process, the cash register 20 can print the sales bonus on a voucher 50. The central controller 10 is connected to a lottery machine 60 which receives entry of the sales bonus on the voucher 50 so that the judgment unit 30 can accumulate the sales bonus. Thereby consumers can select as desired the timing of accumulating the sales bonus to increase the chance of getting awards.

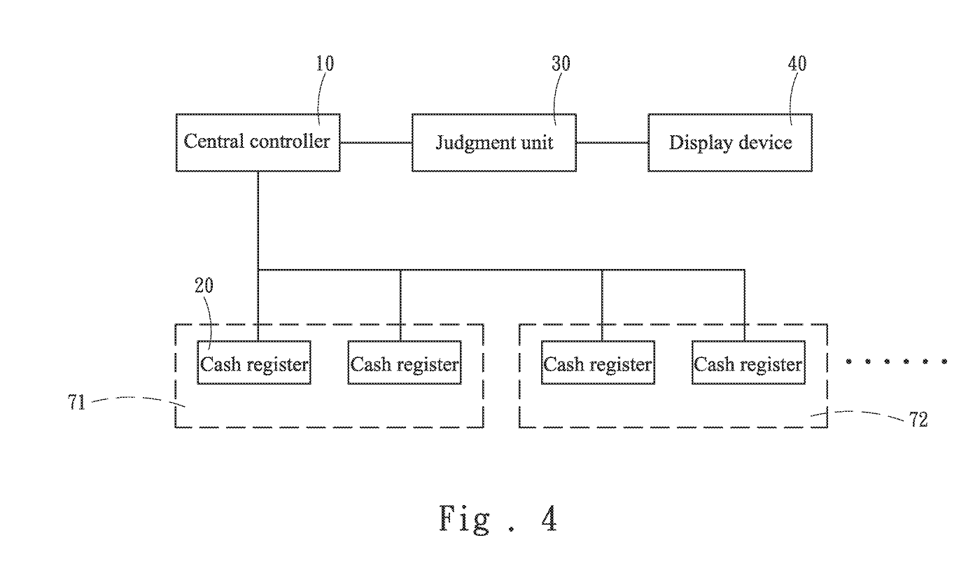

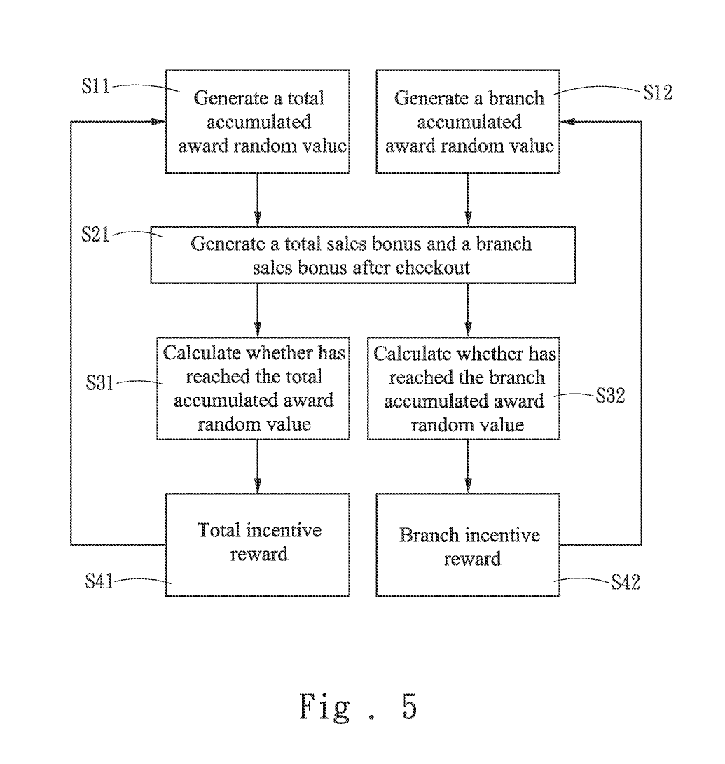

Please refer to FIGS. 4 and 5 for a second embodiment of the invention. It differs from the previous embodiment by dividing the bonus reward into total sales bonus and branch sales bonus. Multiple sets of cash registers 20 are installed on at least two sales locations 71 and 72 and connected to the central controller 10. The two sales locations 71 and 72 shown in the drawings merely serve as examples. The process includes the steps of: S11: generating a total accumulated award random value; S12: generating a branch accumulated award random value; S21: generating a total sales bonus and a branch sales bonus after checkout; S31: calculating whether the total accumulated award random value has been reached; S32: calculating whether the branch accumulated award random value has been reached; S41: offering a total incentive reward; and S42: offering a branch incentive reward.

In this embodiment, the steps S11 and S12 are executed first. The central controller 10 generates a total accumulated award random value and at least two branch accumulated award random values marked with the sales locations 71 and 72, and also sets a total bonus reward ratio and a branch bonus reward ratio.

At step S21, the plurality of cash registers 20 generate a total sales bonus and a branch sales bonus marked with the sales locations 71 and 72 according to the total bonus reward ratio and branch bonus reward ratio after checkout of a consumption activity.

At steps S31, S32, S41 and S42, the judgment unit 30 connected to the central controller 10 to receive the total sales bonus to accumulate the total sales bonus, and to receive the branch sales bonus to accumulate the branch sales bonus according to the marked locations 71 and 72 to generate the at least two branch accumulated sales bonuses marked with the sales locations 71 and 72. In the event that the judgment unit 30 judges that the total accumulated sales bonus is greater than the total accumulated award random value, the total accumulated sales bonus is offered as the incentive reward of the consumption activity, and that any one of the branch accumulated sales bonuses is greater than the at least two corresponding branch accumulated award random values, the branch accumulated sales bonus also is offered as the incentive reward of the consumption activity.

In addition, the central controller 10 also generates randomly the total accumulated award random value and branch accumulated award random values in a designated range of values. In this embodiment a display device 40 also can be included to connect to the judgment unit 30 to display the total accumulated sales bonus and branch accumulated sales bonus.

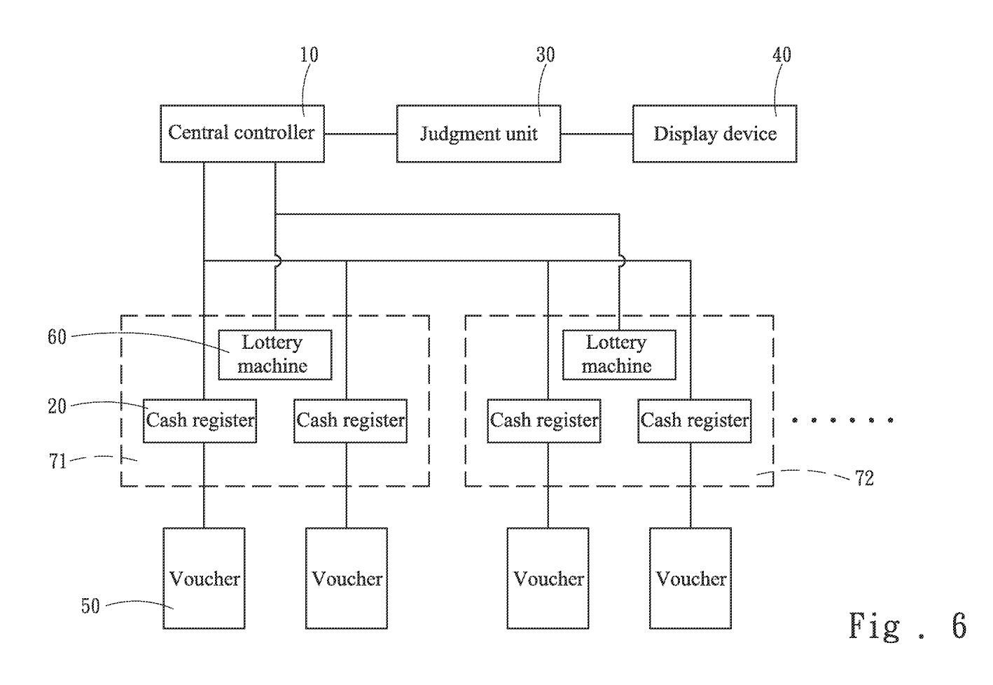

Referring to FIG. 6, in order to alleviate the workload of the cash registers 20, the cash registers 20 can print the total sales bonus and branch sales bonus on a voucher 50. The sales locations 71 and 72 also have respectively a lottery machine 60 installed to connect to the central controller 10 and accept entry of the total sales bonus and branch sales bonus printed onto the vouches 50, then the judgment unit 30 can accumulate the total sales bonus and branch sales bonus.

Thus, the invention, by offering sales bonus and accumulating the sales bonus to a greater amount, can attract attention of consumers. Through changeable setting of the accumulated award random value, when the accumulated sales bonus is over the accumulated award random value the accumulated sales bonus can be given to the consumers at once, thereby the consumers are more motivated and stimulated by unpredictable incentive and tend to consume more enthusiastically. As a result, business revenue can increase. The sales bonus program thus offered can be controlled at a lower cost, and the bonus reward ratio can be easily changed to control promotional cost and maintain desired profits, hence can better meet business requirements.

1-4. (canceled)

5. A sales bonus reward system, comprising:
a plurality of cash registers divided into groups to installed on at least two sales locations;
a central controller to generate a total accumulated award random value and at least two branch accumulated award random values marked with the sales locations, and set a total bonus reward ratio and a branch bonus reward ratio, the plurality of cash registers respectively connecting to the central controller to generate a total sales bonus according to the total bonus reward ratio and to generate a branch sales bonus marked with the sales location according to the branch bonus reward ratio after checkout of a consumption activity; and;
a judgment unit connecting to the central controller to receive the total sales bonus and the branch sales bonuses, the judgment unit accumulating the total sales bonus to generate a total accumulated sales bonus and accumulating the at least two branch sales bonuses according to the marked sales locations to generate the branch accumulated sales bonuses marked with the sales locations, and offering the total accumulated sales bonus as an incentive reward of the consumption activity when the total accumulated sales bonus is greater than the total accumulated award random value, and offering the at least two branch accumulated sales bonuses as the incentive reward of the consumption activity when any one of the branch accumulated sales bonuses is greater than the at least two corresponding branch accumulated award random values.

6. The sales bonus reward system of claim 5, wherein the central controller generates the total accumulated award random value and the at least two branch accumulated award random values in a designated range of values.

7. The sales bonus reward system of claim 5 further including a display device connecting to the judgment unit to display the total accumulated sales bonus and the at least two branch accumulated sales bonuses.

8. The sales bonus reward system of claim 5, wherein the plurality of cash registers print the total sales bonus and the branch sales bonus onto a voucher, each sales location including a lottery machine connecting to the central controller to receive input of the total sales bonus and the branch sales bonus on the voucher for the judgment unit to accumulate the total sales bonus and the branch sales bonus,

9-12. (canceled)

13. A sales bonus reward method, comprising the steps of:
generating a total accumulated award random value and at least two branch accumulated reward random values marked with sales locations and setting a total bonus reward ratio and a branch bonus reward ratio through a central controller;
generating a total sales bonus and a branch sales bonus according to the total bonus reward ratio and the branch bonus reward ratio through at least one cash register after checkout of a consumption activity; and
accumulating the total sales bonus through a judgment unit to generate a total accumulated sales bonus and accumulating the at least two branch sales bonuses through the judgment unit according to the marked sales locations to generate the at least two branch accumulated sales bonuses marked with sales locations, and offering the total accumulated sales bonus as an incentive reward of the consumption activity When the total accumulated sales bonus is greater than the total accumulated award random value, and offering the at least two branch accumulated sales bonuses as the incentive reward of the consumption activity when any one of the branch accumulated sales bonuses is greater than the at least two corresponding branch accumulated award random values.

14. The sales bonus reward method of claim 13, wherein the central controller generates the total accumulated .award random value and the at least two branch accumulated award random values in a designated range of values.

15. The sales bonus reward method of claim 13, wherein the total accumulated sales bonus and the at least two branch accumulated sales bonuses are displayed via a display device.

16. The sales bonus reward method of claim 13, wherein the cash register prints the total sales bonus and the branch sales bonus onto a voucher, the total sales bonus and the branch sales bonus on the voucher being entered into a lottery machine for the judgment unit to accumulate the total sales bonus and the branch sales bonus.
